(19) United States
(12) Patent Application Publication
(10) Pub. No.: US 2004/0037420 A1
(43) Pub. Date: Feb. 26, 2004

(54) Display adapter for comfort telephones

(76) Inventor: Jurgen Brieskorn, Geltendorf (DE)

Correspondence Address: STAAS & HALSEY LLP, SUITE 700, 1201 NEW YORK AVENUE, N.W., WASHINGTON, DC, 20005, US

(21) Appl. No.: 10/415,277

(22) PCT Filed: Oct. 26, 2001
(86) PCT No.: PCT/DE01/04069

(30) Foreign Application Priority Data
Oct. 26, 2000 (DE) 100 53 209.8

(51) Int. Cl. H04M 9/00; H04M 1/00

(52) U.S. Cl. 379/419; 379/428.04

(57) ABSTRACT

An electronic terminal device, especially a telephone, communicates with a graphic input and/or output unit, which is mechanically and electrically detachably connectable to the terminal device through an adapter device.

### CROSS REFERENCE TO RELATED APPLICATIONS

This application is based on and hereby claims priority to PCT Application No. PCT/DE01/04069 filed on Oct. 26, 2001 and German Application No. 100 53 209.8 filed on Oct. 26, 2000, the contents of which are hereby incorporated by reference.

### BACKGROUND OF THE INVENTION

The invention relates to an electronic terminal device, in particular a telephone, having a graphics-capable input and/or output unit.

Electronic terminal devices of this kind, such as enhanced telephones, require, in order to implement a powerful graphical user interface, graphics-capable display components that disadvantageously constitute a significant cost-driving factor in the overall manufacturing costs of such a device.

For this reason, often only some of the users in multi-user private branch exchanges are equipped with what are known as enhanced telephones, that is telephones with graphics-capable display units, usually in the form of an LCD display, so that the remaining users must make do with less convenient standard telephones without such a display.

### SUMMARY OF THE INVENTION

One possible object of the present invention is to create an economical terminal device having a graphics-capable input and/or output unit.

The inventor proposes a terminal device, which can be detachably connected to a graphics-capable input and/or output unit by a suitable adapter device. Such a terminal device can be temporarily connected to a graphics-capable input and/or output unit for performing particular operating functions such as installation, enhanced functions etc. In this way it is possible to use one cost-intensive graphics-capable input and/or output unit for a plurality of such terminal devices.

Here it is conceivable to use one and the same graphics-capable input and/or output unit for convenient operation of the widest range of terminal devices, such as telephones, mobile phones, dishwashers, washing machines, cookers and other domestic appliances.

The terminal device can also have its own integral control unit, such as keypad, buttons, controllers or other control elements that are economic to produce. In this way the normal functions can be performed under the control of an economical control unit integrated in the terminal device, so that the graphics-capable input and/or output unit only needs to be connected to the terminal device for the purpose of performing particular functions. Advantageously a graphics-capable input and/or output unit need not be present in this case for every terminal device.

In a further embodiment, the graphics-capable input and/or output unit is implemented in the form of a PDA (Personal Digital Assistant), which may be produced specifically for this purpose, or which may be an existing PDA.

In a preferred embodiment, the adapter device itself is an interchangeable, standalone, detachable and connectable element having a connecting device for insertion in an adapter receptacle of the terminal device. The adapter receptacle is in this case preferably designed to mechanically retain and make electrical contact with an interface of a PDA.

Advantageously, different types of PDAs can be used for one terminal device here by using different adapter devices having different receptacles and identically designed connecting devices.

It is also conceivable that an adapter is designed as a so-called multiadapter so as to enable multiple different interfaces of different PDAs to be accommodated in one adapter and hence minimize the number of adapters and adapter changes required.

In a further embodiment, the adapter device additionally has a conversion device, which, for instance by signal matching, level adaption, logical signal conversion, protocol conversion etc., enables communication between the PDA interface and the adapter receptacle of the electronic terminal device even when there are different signal types and/or protocols present.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1a shows a schematic diagram of an enhanced telephone, an adapter device and a PDA in disassembled state;

FIG. 1b shows an enhanced telephone having adapter device and PDA as in FIG. 1a in the assembled state, and

FIG. 2 shows an enhanced telephone having multiple different adapter devices and different PDAs.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

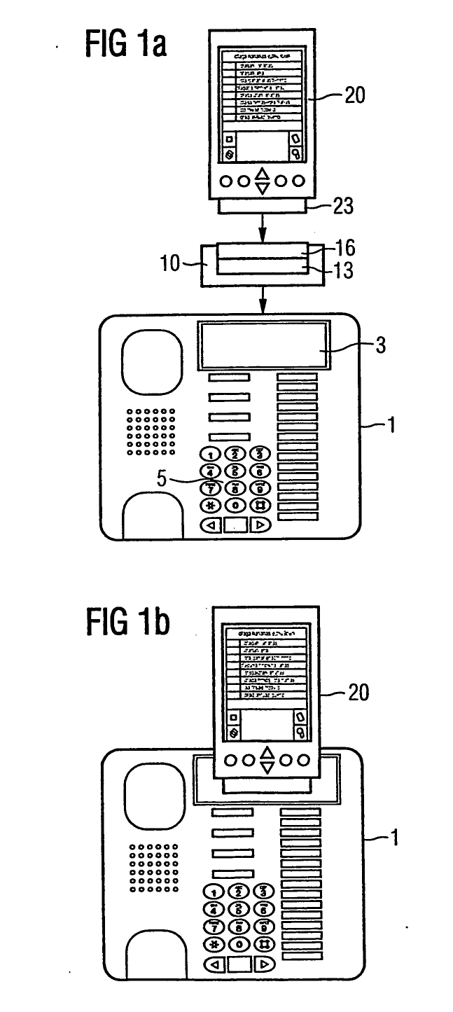

FIG. 1a shows in the form of an exploded diagram how a graphics-capable input and/or output unit in the form of a PDA 20 can be inserted in a terminal device in the form of an enhanced telephone 1 by an adapter device 10 (in the direction of the bold parts in drawing FIG. 1a).

For this purpose the enhanced telephone has in its body an adapter receptacle 3 for a connecting device 13 of the adapter device 10, for example in the form of an adapter foot, so that the adapter device 10 can be connected to the enhanced telephone with a positive mechanical fit and electrical contact, for example by plugging in.

In addition, the adapter device 10 has a receptacle 16 for an interface 23 of a PDA 20, into which the interface 23 of a PDA 20 can likewise be connected with a positive mechanical fit and electrical contact, for example by plugging in.

The result, as can be seen in FIG. 1b. is an enhanced telephone having the PDA 20 as graphics-capable input and/or output unit or as display device, where this display device can be tilted at an angle or vertically upwards, as in traditional enhanced telephones, to provide better viewing by an operating person.

After inserting the PDA 20 in the enhanced telephone 1 by the adapter device 10, standard functions, for example in addition to usual forms of output such as keypad tones or the like, can be displayed graphically. Furthermore, additional functions, such as menu functions, special functions etc., of a control unit, normally in the form of a keypad 5, integrated in the enhanced telephone 1, can be displayed graphically for simpler and more convenient operation.

Furthermore, it is conceivable that the graphics-capable input and/or output unit 20 has a database in which is saved data needed for additional functions such as phonebook, short-code dialing, different key assignments, special functions. Individual data records or complete memory contents can be retrieved from such a database by the terminal device 1, and transferred to a memory held in the terminal device.

It is also conceivable that the data is stored solely in the graphics-capable input and/or output unit 20, and the functions can be selected via a control unit 5 of the terminal device 1 and/or via control units such as a touchscreen or buttons on the PDA 20, without transferring the data to the terminal device 1.

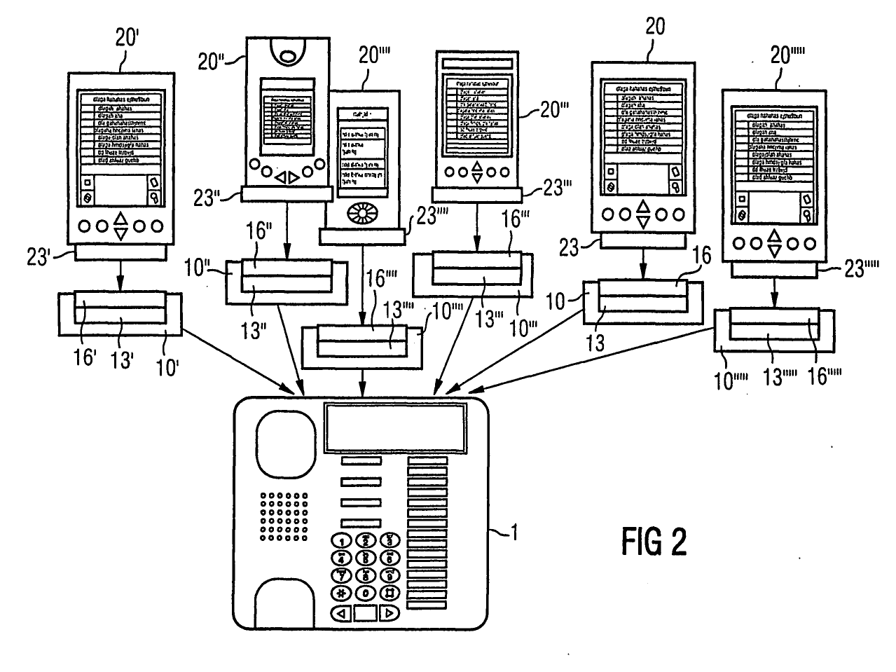

FIG. 2 shows how the widest range of types of graphics-capable input and/or output units in the form of PDAs 20-20′″″ can be inserted in the same terminal device or enhanced telephone 1 by matching adapter devices 10-10′″″. Here, an adapter device can be connected, with a positive mechanical fit and electrical contact, to the relevant PDA 20-20′″″ via a receptacle 16-16′″″ matching a respective interface 23-23′″″ of a PDA 20-20′″″, for example by plugging in.

For this purpose, each of the adapter devices 10-10′″″ has a connecting device 13-13′″″ of identical design for insertion, as described above, into the adapter receptacle 3 of the enhanced telephone with a positive mechanical fit and making an electrical connection.

In order to ensure perfect communication between the PDA 20-20′″″ and the terminal device 1, even when there are differences in the signal type and level between PDA interface 23-23′″″ and adapter receptacle 3 of the enhanced telephone 1, the matching adapter device 10-10′″″ can have a conversion device, which is not shown in greater detail in the drawing, that enables a match or transformation, for example by level adjustment, protocol transformation, PDA conversion, etc.

Of course, it is conceivable that this communication is not only unidirectional toward PDA 20-20′″″, for example when using the PDA 20-20″″ as graphics display, but is also bidirectional, for example for transferring memory contents from PDA 20-20″″ to the terminal device 1 and vice versa.

Advantageously, here information can even be transferred from one terminal device 1 to at least one other terminal device 1, the information being temporarily stored and transported in PDA 20-20′″″ (sequential insertion of the PDA in these different terminal devices). A connection between such terminal devices, for example in the form of a network or a direct individual connection, with the associated overhead such as cabling, network protocols etc., is thus not needed.

Of course, the invention is not limited to the depicted embodiment of an enhanced telephone 1 and a PDA 20-20′″″ that can be connected to this via an adapter device 10-10′″″, but can be applied generally to electronic terminal devices having graphics-capable input and/or output units, such as small terminals for operating everyday devices such as televisions, hi-fi equipment plus remote controls for such devices, dishwashers, washing machines, cookers, microwave ovens, car radios, mobile phones, etc.

The invention has been described in detail with particular reference to preferred embodiments thereof and examples, but it will be understood that variations and modifications can be effected within the spirit and scope of the invention.

1. An electronic terminal device (1), in particular a telephone having a graphics-capable input and/or output unit (20 20′″″), characterized in that the input and/or output unit (20-20′″″) is mechanically and electrically detachably connectable to the terminal device (1) by means of an adapter device (13-13′″″).

2. The terminal device according to claim 1, characterized in that the terminal device (1) is detachably connectable to at least one type of input and/or output unit (20-20′″″) by means of an adapter device (10-10′″″).

3. The terminal device according to claim 2, characterized in that the adapter device (10-10′″″) is designed as a multiadapter, in order to detachably connect multiple different types of input and/or output units (20-20′″″) to the terminal device (1).

4. The terminal device according to one of the preceding claims, characterized in that the terminal device (1) is designed as telephone.

5. The terminal device according to one of the preceding claims, characterized in that the input and/or output unit (20-20′″″) is designed as PDA.

6. An adapter device having a connecting device (13-13′″″) for insertion in an adapter receptacle (3) of an electronic terminal device (1), in particular a telephone, in order to detachably connect the terminal device (1) to a graphics-capable input and/or output unit (20-20′″″), characterized in that the adapter device (10-10′″″) has a receptacle (16-16′″″) in order to accommodate at least one type of input and/or output unit (20-20′″″).

7. The adapter device according to claim 6, characterized in that the adapter device (10-10′″″) is designed as multiadapter in order to accommodate multiple different types of input and/or output units (20-20′″″).

8. The adapter device according to claim 6 or 7, characterized in that the receptacle (16-16′″″) of the adapter device (13-13′″″) is designed in such as way as to mechanically retain and make electrical contact with an interface (23-23′″″) of a PDA

9. The adapter device according to one of the claims 6 to 8, characterized in that the adapter device (10-10′″″) has a conversion unit that converts between signals from the input and/or output unit (20-20′″″) and signals from the terminal device (1).

10. The adapter device according to one of the claims 6 to 9, characterized in that the connecting device (13-13′″″) of the adapter device (10-10′″″) is designed in such a way that the adapter device (10-10′″″) can be inserted in an adapter receptacle (3) of a telephone.

12. The terminal device according to claim 11, wherein the terminal device is detachably connectable to at least one type of input and/or output unit by an adapter device.

13. The terminal device according to claim 12, wherein the adapter device is a multiadapter, to detachably connect multiple different types of input and/or output units to the terminal device.

14. The terminal device according to claim 11, wherein the terminal device is a telephone.

15. The terminal device according to claim 11, wherein the input and/or output unit is designed as personal digital assistant.

16. The terminal device according to claim 13, wherein the terminal device is a telephone.

17. The terminal device according to claim 16, wherein the input and/or output unit is designed as personal digital assistant.

18. The terminal device according to claim 11, wherein
the terminal device communicates using a first signal type,
the input/output unit communicates using a second signal type, different from the first signal type, and
the adapter includes a conversion unit to convert between the first and second signal types.

19. An adapter device comprising:
a connecting device for insertion into an adapter receptacle of an electronic terminal device in order to detachably connect the terminal device to a graphics-capable input and/or output unit; and
a receptacle to accommodate at least one type of input and/or output unit.

20. The adapter device according to claim 19, wherein the adapter device is a multiadapter to accommodate multiple different types of input and/or output units.
